(19) United States
(12) Patent Application Publication
(10) Pub. No.: US 2009/0105358 A1
(43) Pub. Date: Apr. 23, 2009

(54) SILICONE-CONTAINING FOAMS

(75) Inventors: Jens Cremer, Munich (DE); Peter Ball, Emmerting (DE); Volker Stanjek, Ampfing (DE); Richard Weidner, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/293,961

(22) PCT Filed: Mar. 1, 2007
(86) PCT No.: PCT/EP07/51961

§ 371 Date: Sep. 22, 2008

(30) Foreign Application Priority Data
Mar. 23, 2006 (DE) 10 2006 013 416.8

(51) Int. Cl. C08J 9/06; C08L 75/04; C08J 9/12

(52) U.S. Cl. 521/87; 521/137; 521/88; 521/97; 521/94; 521/98; 521/82; 521/91

(57) ABSTRACT

Foamable, isocyanate-functional organopolysiloxanes with more uniform molecular weights are produced by reaction of an aminoalkyl or hydroxyalkyl functional organopolysiloxane with a stoichiometric excess of a di- or polysiocyanate in the presence of a compatibilizer which provides a homogenous reaction mixture.

The invention relates to a process for preparing isocyanate-functional organopolysiloxanes, foamable compositions comprising these and also the foams which can be produced therefrom.

Both pure silicone foams and flexible polyurethane foams produced from organic polyols and diisocyanates or polyisocyanates have been known for a long time. However, both groups of materials have specific advantages and disadvantages. Thus, although silicone foams generally have a good high- and low-temperature stability and excellent flame resistance, they at the same time have a comparatively high density and an only very moderate mechanical property profile. Flexible polyurethane foams, on the other hand, usually have excellent mechanical properties. A disadvantage of many polyurethane foams is, however, burning behavior which is unsatisfactory for many applications and can be compensated, if at all, only by means of large amounts of added flame retardants.

The use of silicone-polyurethane copolymers, i.e. polysiloxanes which also contain polyurethane and/or urea units, makes it possible to develop new types of foams which have novel combinations of properties which can be tailored precisely to the respective application. Thus, foams which, in particular, have good mechanical properties in combination with a significantly improved burning behavior compared to conventional polyurethane foams can be produced in this way.

WO 03/080696 describes silicone foams which can be produced from particular hydroxyalkyl- and/or aminoalkyl-functional polysiloxanes and diisocyanates or polyisocyanates. Crosslinking of the silicones occurs here during foam formation. Water, which reacts with the isocyanates which are used in excess to liberate carbon dioxide and form urea units, serves as blowing agent.

WO 03/080696 describes two processes for producing foams. In one process, the hydroxyalkyl- and/or aminoalkyl-functional siloxane is firstly emulsified in water and the emulsion obtained is subsequently reacted with diisocyanates or polyisocyanates. In the second process, the hydroxyalkyl- and/or aminoalkyl-functional siloxane is firstly reacted with an excess of the diisocyanate or polyisocyanate to form an isocyanate-functional siloxane which is then mixed with water in a second process step and thereby foamed.

However, both the processes described in WO 03/080696 have the disadvantage that the resulting foams often do not display a satisfactory property profile. Thus, for example, the foam structures obtained are often only moderate. In particular, the foams generally display “sweating-out” of siloxane molecules which have remained uncrosslinked.

DE 41 08 326 C1 describes silicone foams which can be produced by reaction of hydroxyalkyl-functional polysiloxanes with diisocyanates or polyisocyanates. The siloxane foams are produced using methods comparable to those described in WO 03/080696. The same problems therefore also occur here.

In addition, the reaction of hydroxyalkyl- or aminoalkyl-terminated polysiloxanes with diisocyanates or polyisocyanates is known from further literature references, including U.S. Pat. No. 5,512,650 or WO 97/40103. However, this reaction has been described not for producing foams but exclusively for producing elastomers or prepolymers for hot melt or sealant applications. In addition, the compounds described there are, owing to their high molar masses and the very high viscosities associated therewith, unsuitable for use in a process for producing foams from prepolymers, in which crosslinking of the prepolymers is to occur only during foam formation and at low temperatures.

It was an object of the invention to develop siloxane-polyurethane copolymers which do not have the disadvantages of the prior art.

The invention provides a process for preparing organically modified organopolysiloxanes (S) which can be foamed by means of blowing agents selected from among water and physical blowing agents and cured to form foams and have on average at least one isocyanate function per molecule, in which organopolysiloxanes (S1) having at least one reactive group selected from among an aminoalkyl group and a hydroxyalkyl group per molecule are reacted with polyisocyanates (J) having at least 2 isocyanate groups per molecule in the presence of a component (L) which acts as solubilizer between the reactants (S1) and (J), with at least 1.05 mol of isocyanate groups being present per mole of reactive group.

In the process of the invention, isocyanate-functional organopolysiloxanes (S) or, if appropriate, mixtures of the siloxanes with polyisocyanate (J) are obtained. The polysiloxanes (S) obtained are preferably linear or branched.

The organopolysiloxanes (S) or mixtures of the organopolysiloxanes (S) and excess polyisocyanates (J) are usually used in foamable compositions (Z) which additionally contain further additives.

The organopolysiloxanes (S) of the invention and mixtures (Z) containing these are used for producing foams, preferably rigid or flexible foams, in particular flexible foams.

The invention is based on the surprising discovery that the disadvantages of the processes described in the prior art can be attributed to the fact that the hydroxyalkyl- and/or aminoalkyl-functional siloxanes (S1) are immiscible or only slightly miscible with the diisocyanates or polyisocyanates (J). This leads to part of the siloxanes not coming into contact with the isocyanates in the production of silicone-polyurethane copolymer foams according to the teachings of the prior art and thus remaining uncrosslinked and being able to “sweat out”.

The addition of the solubilizing component (L) results in better mixing of the reactants (S1) and (J) being achieved during the reaction. The two components preferably form a homogeneous phase during the reaction. This not only leads to the silicones (S1) reacting substantially more completely with the excess of isocyanate but also results in the resulting isocyanate-functional siloxanes (S) having a significantly more homogeneous molar mass distribution. Thus, in the absence of the solubilizing component (L), the reactants (S1) and (J) are present in a two-phase mixture so that the reaction takes place mainly at the phase boundary. This would, if not only the isocyanates (J) but also the siloxanes (S1) mostly have at least two reactive groups, lead to formation of extremely high molecular weight compounds since both the bifunctional or polyfunctional siloxanes (S1) and the polyfunctional isocyanates (J) react largely to completion at the phase boundary.

If, on the other hand, the reactants (S1) and (J) are present in a largely homogeneous phase during the reaction, a major part of the isocyanate functions which are present in excess do not react, i.e. a major part of the isocyanates (J) used reacts only with in each case one isocyanate group and thus leads to formation of chain terminations which limit the molar mass. The addition of the component (L) which acts as solubilizer between the reactants (S1) and (J) thus enables the viscosity of the resulting siloxanes (S) to be significantly reduced and/or gelling of the reaction mixture to be prevented.

The solubilizing component (L) can in principle be any compound or mixture of various compounds which noticeably improves the mutual solubility of the siloxanes (S1) and the isocyanates (J). The component (L) is preferably inert or largely inert toward isocyanates. In a preferred embodiment of the invention, the component (L) comprises compounds which remain in the finished foam, e.g. low molecular weight flame retardants having appropriately good solubilizing properties for the components (S1) and (J).

However, the component (L) is particularly preferably a solvent or a solvent mixture which is able to dissolve both the siloxanes (S1) and the isocyanates (J).

The solvent (L) is preferably added in an amount which is sufficient to dissolve both reactants (S1) and (J) completely, so that they react in a single-phase solution. The amount of solvent (L) is particularly preferably chosen so that it is just sufficient to achieve a reaction of siloxane (S1) and isocyanate (J) in a single-phase solution. Preference is likewise given to solvents having good solvent properties, so that very small amounts of solvent are sufficient.

Examples of suitable solvents (L) are ethers, in particular aliphatic ethers such as dimethyl ether, diethyl ether, methyl t-butyl ether, diisopropyl ether, dioxane or tetrahydrofuran, esters, in particular aliphatic esters such as ethyl acetate or butyl acetate, ketones, in particular aliphatic ketones such as acetone or methyl ethyl ketone, stearically hindered alcohols, in particular aliphatic alcohols, such as t-butanol, tertiary amines such as triethylamine, tributylamine or pyridine, amides such as DMF, aromatic hydrocarbons such as toluene or xylene, aliphatic hydrocarbons such as pentane, cyclopentane, hexane, cyclohexane, heptane, chlorine compounds, in particular chlorinated hydrocarbons such as dichloromethane or chloroform, and CO₂. The solvents (L) can be used individually or as mixtures. Preferred solvents (L) are ketones, ethers, chlorine compounds and esters, with particular preference being given to acetone, dioxane, methyl ethyl ketone, methyl t-butyl ether, dichloromethane and tetrahydrofuran.

The solubilizing component (L) preferably has a boiling point of from 20 to 120° C., in particular from 30 to 80° C., at 0.10 MPa.

In a preferred embodiment of the invention, a solvent or solvent mixture is used as solubilizing component (L) and the solvent or solvent mixture is completely or partly removed after the reaction of the organopolysiloxanes (S1) and the diisocyanates and/or polyisocyanates (J) is complete or at least largely complete.

Particular preference is given to the following procedure: the organopolysiloxanes (S1) having at least one group selected from among an aminoalkyl group and a hydroxyalkyl group per molecule are reacted with an excess of polyisocyanates (J) having at least 2 isocyanate groups per molecule in the presence of a solvent (L) to form the isocyanate-functional siloxanes (S). Here, the siloxanes (S1) preferably react completely so as to give a mixture which comprises not only the isocyanate-functional siloxanes (S) but also proportions of unreacted polyisocyanates (J). The solvent (L) can subsequently be removed completely or partly by distillation. The resulting foamable mixture preferably remains homogeneous, since the isocyanate-modified siloxanes (S) have a sufficient solvent capability for the excess isocyanates (J) after the organomodification.

If appropriate, further additives can be added to this mixture at any point in time during or after their preparation in order to obtain foamable compositions (Z).

The organopolysiloxanes (S1) are preferably linear or branched. As organopolysiloxanes (S1), preference is given to using siloxanes whose aminoalkyl or hydroxyalkyl groups correspond to the general formula (1)

—O—(SiR¹R²)—R³-Z (1)

where
R¹ is a monovalent C₁-C₁₂-hydrocarbon radical which may be substituted by —CN or halogen and in which one or more nonadjacent methylene units may be replaced by —O— or NR³ groups, or a phenyl radical which may be substituted by C₁-C₆-alkyl radicals, —CN or halogen,
R² is a hydrogen atom or a radical R¹,
R³ is a divalent C₁-C₁₂-hydrocarbon radical which may be substituted by cyano, alkyl, hydroxy, amino, aminoalkyl, hydroxyalkyl or halogen and in which one or more nonadjacent methylene units may be replaced by —O— or NR³ groups and
Z is an OH or NH₂ group.

Preferred radicals R¹ are unbranched alkyl groups, preferably ones having from 1 to 6 carbon atoms, or aromatic hydrocarbons. Methyl groups are particularly preferred radicals R¹. Radicals R² are preferably unsubstituted. Preferred radicals R³ are, in particular, linear alkyl chains having from 1 to 6, preferably 1 or 3, carbon atoms or cyclic hydrocarbon radicals. Preferred radicals R³ also include alkylene chains which have from 1 to 10 carbon atoms, preferably 3 or 5 carbon atoms, and whose carbon chain is interrupted by one or more oxygen atoms or an NR⁴ group. Preferred radicals R⁴ are hydrogen, alkyl groups, aryl groups, aminoalkyl groups or hydroxyalkyl groups, preferably ones having from 1 to 6 carbon atoms, with particular preference being given to hydrogen and methyl groups. The group Z is particularly preferably an amine function.

Preference is given to using branched or unbranched organopolysiloxanes (S1) which have at least 90%, in particular at least 95%, of their chain ends terminated by aminoalkyl or hydroxyalkyl groups of the general formula (1). It is possible, if appropriate, for both aminoalkyl and hydroxyalkyl groups of the general formula (1) to be present on an organopolysiloxane molecule (S1).

Particular preference is given to using organopolysiloxanes (S1) which either consist exclusively of or comprise at least 50% by weight, preferably at least 70% by weight, particularly preferably at least 90% by weight, of linear siloxanes of the general formula (2)

Z—R³—[—SiR¹R²O—]ₘ—SiR¹R²—R³-Z (2)

where
m is an integer having an average value in the range from 1 to 10 000 and
R¹, R², R³ and Z are as defined above.

Preferred average values of m are from 10 to 1000, with particular preference being given to average values of from 15 to 500, in particular from 30 to 300.

In a preferred embodiment of the invention, the siloxanes (S1) of the general formula (2) are mixed with further siloxanes (S1) which have an average of more than two groups selected from among aminoalkyl functions and hydroxyalkyl functions. These can be either branched siloxanes (S1) terminated by groups selected from among aminoalkyl functions and hydroxyalkyl functions or unbranched siloxanes having lateral groups selected from among aminoalkyl functions and hydroxyalkyl functions.

In a particularly preferred process, the linear organopolysiloxanes (S1) of the general formula (2) are prepared from organopolysiloxanes of the general formula (3)

H—O[—SiR¹₂O]ₘ—H (3)

and organosilicon compounds of the general formulae (4) to (6)

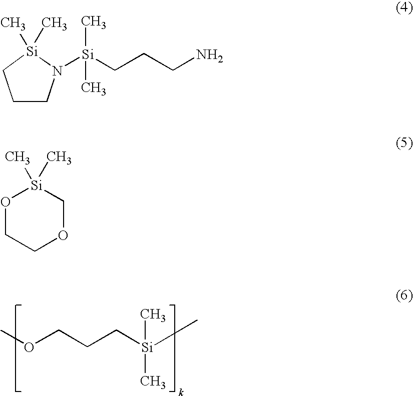

where
k is an integer of at least 2 and
R¹ and m are as defined above.

In one embodiment of the invention, siloxanes having phosphonatoalkyl functions of the formula (7)

—R⁵—P(O)(OR⁶)₂ (7)

where R⁵ has one of the meanings of R³ and R⁶ has one of the meanings of R¹, in addition to the aminoalkyl and/or hydroxyalkyl functions are used as component (S1). The phosphate functions can improve the compatibility between the siloxanes (S1) and the isocyanates (J).

The siloxanes (S1) used in the process of the invention preferably have a very small proportion of siloxanes which are not reactive toward isocyanates. In particular, they preferably have a very low proportion of cyclic siloxanes which are not reactive with isocyanates. Thus, unreactive siloxanes may act as antifoams and thus adversely affect the foam structure of the cured foams. It may be advantageous to remove cyclic siloxanes which are not reactive towards isocyanates from the siloxanes (S1) by distillation before the siloxanes (S1) are used in the process of the invention.

As polyisocyanates (J), it is possible to use all known diisocyanates or polyisocyanates. Preference is given to using polyisocyanates (J) of the general formula (8)

Q(NCO)ₙ (8)

where
Q is an n-functional aromatic or aliphatic hydrocarbon radical and
n is an integer of at least 2.

Q preferably has from 4 to 30 carbon atoms. n is preferably an integer of not more than 5. Examples of diisocyanates (J) which can be used are diisocyanatodiphenylmethane (MDI), both in the form of crude or technical-grade MDI and in the form of pure 4,4′ or 2,4′ isomers or compositions in which they are present, tolylene diisocyanate (TDI) in the form of its various regioisomers, diisocyanatonaphthalene (NDI), isophorone diisocyanate (IPDI), 1,3-bis(1-isocyanato-1-methylethyl)benzene (TMXDI) or hexamethylene diisocyanate (HDI). Examples of polyisocyanates (J) are polymeric MDI (p-MDI), triphenylmethane triisocyanate or biuret or isocyanurate trimers of the above-mentioned isocyanates. The diisocyanates and/or polyisocyanates (J) can be used either alone or in admixture with one another.

In the reaction of organosiloxanes (S1) with the polyisocyanates (J), the polyisocyanates (J) are preferably used in such an excess that at least 1.5 mol, in particular from 2 to 10 mol, of isocyanate groups are used per mole of reactive aminoalkyl and hydroxyalkyl groups of the organopolysiloxanes (S1). The molar excess of isocyanates is preferably consumed in the reaction with water during foam formation.

In the preparation of the organosiloxanes (S), it is possible for not only the siloxanes (S1) and the polyisocyanates (J) but also further components having isocyanate functions and/or isocyanate-reactive groups to be used and concomitantly be incorporated into the organosiloxanes (S). Examples which may be mentioned here are monoisocyanates, isocyanate-functional organic oligomers or (pre)polymers, monomeric alcohols, monomeric diols such as glycol, propanediol, butanediol, monomeric oligools such as pentaerythritol or trihydroxymethylethane, oligomeric or polymeric alcohols having one, two or more hydroxyl groups, e.g. polyethylene oxide or polypropylene oxide, water, monomeric amines having one, two or more amine functions, e.g. ethylenediamine, hexamethylenediamine, and also oligomeric or polymeric amines having one, two or more amine functions. The proportion by weight of these additional compounds is typically less than 30% by weight, preferably less than 15% by weight and particularly preferably less than 5% by weight, based on the isocyanate-functional organosiloxanes (S1).

The preparation according to the invention of the siloxanes (S) can be accelerated by the use of catalysts (K). As catalysts (K), preference is given to using acidic or basic compounds, e.g. partly esterified phosphoric acids, carboxylic acids, partly esterified carboxylic acids, alkylammonium hydroxides, ammonium alkoxides, alkylammonium fluorides or amine bases, organotin compounds, organozinc compounds, organotitanium compounds. If appropriate, the catalysts (K) used are deactivated after the reaction is complete, e.g. by addition of catalyst poisons or, in the case of acidic or basic catalysts (K), by neutralization. This deactivation can improve the storage stability of the siloxanes (S) or the compositions (Z) in which they are present.

The organopolysiloxanes (S) of the invention or mixtures of the organopolysiloxanes (S) and excess polyisocyanates (J) are usually used in foamable compositions (Z) which additionally contain further additives. The addition of all additives can be carried out at any point in time before, during or after the preparation according to the invention of the organosiloxanes (S).

A preferred addition to the foamable compositions (Z) comprises fillers (F). Here, it is possible to use all nonreinforcing fillers, i.e. fillers having a BET surface area of up to 50 m²/g, e.g. chalk, or reinforcing fillers, i.e. fillers having a BET surface area of at least 50 m²/g, e.g. carbon black, precipitated silica or pyrogenic silica. In particular, both hydrophobic and hydrophilic pyrogenic silicas are preferred fillers. In a particularly preferred embodiment of the invention, a pyrogenic silica whose surface has been modified with hydroxyalkyl or in particular aminoalkyl functions is used. This modified silica can be chemically built into the foam polymer. The fillers (F), in particular pyrogenic silicas used as fillers, can perform various functions. Thus, they can be used for adjusting the viscosity of the foamable mixture (Z). In particular, however, they can perform a “support function” during foaming and thus lead to foams having a better foam structure. Finally, the mechanical properties of the resulting foams can also be improved significantly by the use of fillers (F), in particular by the use of pyrogenic silica.

Furthermore, the foamable compositions (Z) can contain catalysts (K2) which accelerate curing of the foam. Suitable catalysts (K2) are, inter alia, organotin compounds. Examples are dibutyltin dilaurate, dioctyltin dilaurate, dibutyltin diacetate, dibutyltin dioctoate and dibutyltin bis(dodecylmercaptide). In addition, it is also possible to use tin-free catalysts (K2), e.g. organic titanates, iron catalysts such as organic iron compounds, organic and inorganic heavy metal compounds or amines. An example of an organic iron compound is iron(III) acetylacetonate. Examples of amines are triethylamine, tributylamine, 1,4-diazabicyclo[2.2.2]octane, N,N-bis(N,N-dimethyl-2-aminoethyl)methylamine, N,N-dimethylcyclohexylamine, N,N-dimethylphenylamine, bis(N,N-dimethylaminoethyl)ether, N,N-dimethyl-2-aminoethanol, N,N-dimethylamino-pyridine, N,N,N,N-tetramethylbis(2-aminoethyl)methyl-amine, 1,5-diazabicyclo[4.3.0]non-5-ene, 1,8-diazabicyclo[5.4.0]undec-7-ene, N-ethylmorpholine and N,N′-dimethylaminopyridine.

The catalysts (K2) can be used individually or as a mixture. The catalysts (K) used in the preparation of the siloxanes (S) may at the same time also serve as catalysts (K2) for curing of the foam.

Based on the foamable composition (Z), the catalyst (K2) is preferably used in an amount of 0.1-6.0% by weight, particularly preferably in an amount of 0.3-4.0% by weight.

In many cases, it is advantageous to add foam stabilizers (ST) to the foamable compositions (Z). Suitable foam stabilizers (ST) are, for example, the commercial silicone oligomers modified by polyether side chains which can also be used for producing conventional polyurethane foams. The foam stabilizers are used in amounts of up to 6% by weight, preferably from 0.3 to 3% by weight, in each case based on the foamable compositions (Z).

Furthermore, the addition of cell regulators, thixotropes and/or plasticizers can be advantageous. To improve the fire resistance further, flame retardants, e.g. phosphorus-containing compounds, especially phosphates and phosphonates, and also halogenated polyesters and polyols or chloroparaffins, can additionally be added to the foamable compositions (Z).

In addition, the compositions (Z) can also contain physical blowing agents (T). As physical blowing agents (T), preference is given to using low molecular weight hydrocarbons such as propane, butane or cyclopentane, dimethyl ether, fluorinated hydrocarbons such as 1,1-difluoroethane or 1,1,1,2-tetrafluoroethane or CO₂. Production of the foam can, if appropriate, be carried out exclusively by means of the physical blowing agents (T). However, foam formation is usually effected by means of a reaction of the isocyanate-functional siloxanes with water as chemical blowing agent. However, in this case, too, use of physical blowing agents (T) in combination with water as chemical blowing agent can be advantageous in order to obtain foams having a lower density.

The siloxanes (S) or the compositions (Z) containing these are preferably used for producing siloxane-polyurethane copolymer foams or siloxane-polyurea copolymer foams. The siloxanes (S) or compositions (Z) can be used in the form of one-component systems. Foam formation is effected here by means of a physical blowing agent (T). After application of the foam, it cures by reaction with atmospheric moisture.

However, the siloxanes (S) or the compositions (Z) are preferably used in two-component systems in which the two components are mixed with one another shortly before foaming. Curing of the foam is then effected by reaction of the two components with one another. Here, the siloxanes (S) or the compositions (Z) represent the first foam component. As second component, it is in principle possible to use water and also all compounds (V) having preferably at least two isocyanate-reactive functions. Examples of suitable compounds (V) are aminoalkyl- or hydroxyalkyl-functional siloxanes (S1) and also monomeric alcohols, monomeric diols such as glycol, propanediol, butanediol, monomeric oligools such as pentaerythritol or trihydroxymethylethane, oligomeric or polymeric alcohols having one, two or more hydroxyl groups, e.g. ethylene glycol or propylene glycol, water, monomeric amines having one, two or more amine functions, e.g. ethylenediamine, hexamethylene-diamine, and also oligomeric or polymeric amines having one, two or more amine functions. Foam formation is in this case effected by means of a physical blowing agent (T) and curing of the foam is brought about by reaction of the siloxanes (S) with the second foam component.

However, the second foam component preferably contains, in particular, water as isocyanate-reactive compound.

Both foam formation and curing of the foam in this case occur by reaction of the siloxanes (S) with the water. However, foam formation can also be aided by use of a physical blowing agent (T), and curing of the foam can be aided by use of further isocyanate-reactive compounds (V) having preferably at least two isocyanate-reactive functions. In a preferred embodiment of the invention, the second component contains no further isocyanate-reactive compounds in addition to water.

If the siloxanes (S) or compositions (Z) are used in the form of 2-component mixtures, it is possible for all additives such as the catalysts (K2), fillers (F), foam stabilizers (ST), physical blowing agents (T), cell regulators, thixotropes and/or fire retardants to be present in either of the two components or, if appropriate, even simultaneously in both components. In a preferred embodiment of the invention, the catalysts (K2) are, in particular, added not to the siloxanes (S) or compositions (Z) but to the second, isocyanate-reactive component in order to increase the storage stability of the siloxanes (S) or of the compositions (Z) in which they are present.

If the siloxanes (S) or compositions (Z) are used in the form of 2-component mixtures, it can also be advantageous to use one or more additional solubilizing components (L2) to improve the compatibility of the two foam components with one another. This applies particularly when the second foam component contains water as isocyanate-reactive compound. This further solubilizing component (L2) can be an emulsifier (E) which makes possible or aids the formation of silicone-water emulsions. Preference is in this case given to using 0.001-0.5 g, particularly preferably 0.02-0.1 g, of emulsifier per 1 g of water. Examples of emulsifiers (E) are fatty alcohol polyglycol ethers, fatty alcohol polyglycerol ethers, polyoxyethylene glycerol esters, isotridecanol ethoxylate or polyol-modified silicone oils.

However, in a particularly preferred embodiment of the invention, solvents or solvent mixtures are used as solubilizing components (L2). The combined use of solvents and emulsifiers (E) is also particularly advantageous. Here, it is in principle possible to use the same solvents or solvent mixtures which are also used as component (L). The solvent or solvent mixture is preferably used in the second, water-containing foam component, with water-soluble solvents being particularly preferred. Examples of particularly useful solvents are THF, dioxane, chloroform or acetone.

All the above symbols in the above formulae have their meanings independently of one another in each case. In all formulae, the silicon atom is tetravalent.

Unless indicated otherwise, all amounts and percentages are by weight, all pressures are 0.10 MPa (abs.) and all temperatures are 20° C.

### EXAMPLE 1

49.10 g of a linear organopolysiloxane of the formula H₂N—(CH₂)₃—[(CH₃)₂—SiO]₁₂₉Si(CH₃)₂—(CH₂)₃—NH₂ were reacted in 50 ml of absolute THF with p-MDI (0.10 g in 30 ml of absolute THF) at 0° C. for 50 minutes. The solution obtained in this way was subsequently added dropwise to a solution of TDI (4.30 g in 18 ml of absolute THF) at 0° C. over a period of 30 minutes and thus reacted at 0° C. The reaction mixture was then warmed to room temperature, stirred for a further two hours and subsequently freed of the solvent under reduced pressure.

### EXAMPLE 2

10.00 g of the prepolymer from Example 1 were dissolved in 3.2 ml of absolute THF and admixed with 0.08 g of N,N,N′,N′-tetramethylbis(2-aminoethyl)methylamine (Jeffcat® PMDETA from Huntsman Corp.) as catalyst and 0.11 g of emulsifier (Atlas® G-1300 from Deutsche ICI GmbH, Frankfurt am Main). The mixture obtained in this way was firstly processed by means of a high-speed precision glass stirrer to form a homogeneous emulsion. 0.18 g of water were then quickly added and the mixture was again emulsified by means of a high-speed precision glass stirrer to give a homogeneous mixture. After about 30 seconds, an exothermic reaction with foam formation commenced. Foam formation was complete after about 30 seconds more, while evolution of heat continued for about 60 seconds. This gave an elastic, coarse-pored foam which was found to be noncombustible in a Bunsen burner flame.

### EXAMPLE 3

The procedure of Example 2 was repeated with the difference that the amount of water was halved to 0.09 g. This gave an elastic, noncombustible foam having a coarse foam structure.

### EXAMPLE 4

The procedure of Example 2 was repeated with the difference that the water was added in the form of an ether solution (0.18 g of water in 3.0 ml of THF). This gave an elastic, noncombustible foam having a uniform fine pore size.

### EXAMPLE 5

The procedure of Example 4 was repeated with the difference that the amount of the catalyst N,N,N′,N′-tetramethylbis(2-aminoethyl)methylamine was doubled to 0.16 g. This gave an elastic, noncombustible foam having a uniform fine pore size. Compared to the foam from Example 4, the average pore size was slightly smaller.

### EXAMPLE 6

The procedure of Example 2 was repeated with the difference that 0.05 g of a hydrophilic, pyrogenic silica (HDK® V15 from Wacker) was homogeneously dispersed in the prepolymer before the addition of water. This resulted in an elastic, noncombustible foam having a fine pore size. Although the pore size was comparable with that of the foam from Example 5, this foam had a significantly greater mechanical hardness.

### EXAMPLE 7

The procedure of Example 2 was repeated with the difference that 0.20 g of a hydrophilic, pyrogenic silica (HDK® V15 from Wacker) was homogeneously dispersed in the prepolymer before the addition of water. This gave an elastic, noncombustible foam having a medium pore size. Compared to the foam from Example 6, this foam had a high density and an extremely high mechanical hardness.

1-9. (canceled)

10. A process for preparing foamable, organically modified organopolysiloxanes (S) comprising:
reacting at least one organopolysiloxane (S1) having per molecule at least one reactive group selected from the group consisting of aminoalkyl and hydroxyalkyl groups,
with at least one polyisocyanate (J) having at least 2 isocyanate groups per molecule,
in the presence of a component (L) which acts as solubilizer between the reactants (S1) and (J), with at least 1.05 mol of isocyanate groups being present per mole of reactive group,
wherein the organically modified organopolysiloxanes (S) can be foamed by means of blowing agents selected from among water and physical blowing agents and cured to form foams, and have on average at least one isocyanate function per molecule.

11. The process of claim 10, wherein component (L) is a solvent or solvent mixture which is a solvent for both the siloxane(s) (S1) and the isocyanate(s) (J).

12. The process of claim 10, wherein the component (L) is a solvent, added in an amount which is sufficient to completely dissolve both reactants (S1) and (J).

13. The process of claim 10, wherein the component (L) comprises a solvent selected from the group consisting of ethers, esters, ketones, tertiary amines, aromatic and aliphatic hydrocarbons, chlorinated hydrocarbons, CO₂, and mixtures thereof.

14. The process of claim 10, wherein the aminoalkyl or hydroxyalkyl groups of the organopolysiloxanes (S1) correspond to the formula (1)
—O—(SiR¹R²)—R³-Z (1)
where
R¹ is a monovalent C₁-C₁₂-hydrocarbon radical optionally substituted by —CN or halogen and in which one or more nonadjacent methylene units are optionally replaced by —O— or NR³ groups, or a phenyl radical optionally substituted by C₁-C₆-alkyl radicals, —CN or halogen,
R² is a hydrogen atom or a radical R¹,
R³ is a divalent C₁-C₁₂-hydrocarbon radical optionally substituted by cyano, alkyl, hydroxy, amino, aminoalkyl, hydroxyalkyl or halogen and in which one or more nonadjacent methylene units are optionally replaced by —O— or NR³ groups and
Z is an OH or NH₂ group.

15. An isocyanate-functional organopolysiloxane (S) prepared by the process of claim 10.

16. A foamable composition comprising at least one organopolysiloxanes (S) of claim 15, and further additives.

17. The foamable composition of claim 16 which comprises a mixture of organopolysiloxanes (S) and polyisocyanates (J).

18. A foam prepared by foaming the organopolysiloxanes (S) of claim 15.

19. The foamable composition of claim 16, which further comprises water as a reactive blowing agent, and a catalyst.

20. The foamable composition of claim 16, further comprising a pyrogenic silica having a surface area greater than 50 m²/g.
